(19) United States
(12) Patent Application Publication
(10) Pub. No.: US 2009/0096297 A1
(43) Pub. Date: Apr. 16, 2009

(54) Linear motor, drive stage, and XY drive stage

(76) Inventors: Houng Joong Kim, Mito (JP); Kaoru Saito, Fujieda (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/246,557

(22) Filed: Oct. 7, 2008

(30) Foreign Application Priority Data
Oct. 9, 2007 (JP) 2007-263374

(51) Int. Cl. H02K 41/03

(52) U.S. Cl. 310/12

(57) ABSTRACT

A linear motor is provided in which a magnetic attracting force acting between a stator and a mover is mechanically cancelled by arrangement of armature units, and can be easily assembled. The linear motor includes a primary-side member in which magnets are arranged in a traveling direction and a secondary-side member in which armature units each including a core and an armature winding are arranged in the traveling direction and in which a spacer is interposed between the armature units. The primary- and secondary-side members relatively move. When a side-surface member is slid in Y direction, the dovetail groove of the side-surface member and the dovetail tenon of the spacer are fitted together, and are combined together in a dovetail joint. When an upper-surface member is slid in the X direction, the dovetail groove and tenon are fitted together to have a dovetail joint there. The armature units and the spacers are combined together. A driving stage and an XY driving stage including this linear motor are also provided.

### CROSS REFERENCE TO RELATED APPLICATIONS

This application claims the foreign priority benefit under Title 35, United States Code, §119(a)-(d) of Japanese Patent Application No. 2007-263374, filed on Oct. 9, 2007 in the Japan Patent Office, the disclosure of which is herein incorporated by reference in its entirety.

### BACKGROUND OF THE INVENTION

1. Field of the Invention

This invention relates to a linear motor, a driving stage using the linear motor, and an XY driving stage using the linear motor.

2. Description of the Related Art

A conventional linear motor has such a structure that a rotating electrical machine is cut open and is unrolled linearly. This linear motor includes, for example, a stator having an armature winding and a mover having a permanent magnet supported so as to be relatively movable to the stator with an air-gap therebetween. Therefore, a great magnetic attracting force acts between the stator and the mover. This is a problem in that, to keep the air-gap constant against the magnetic attracting force, a great load is on a supporting mechanism, and a linear motor or an apparatus using the linear motor has difficulty in reduction in size or simplifying.

Therefore, to solve this problem, a linear motor is known in which a load on the supporting mechanism of the mover is intended to be reduced by canceling out the magnetic attracting force acting between the stator and the mover. JP 10-174418 (see paragraph [0006] and FIG. 1 to FIG. 4) discloses this type of linear motor. This linear motor is structured to be reduced in size and to improve reliability by disposing a stator having an armature winding so as to face a mover with an air-gap therebetween in a C-type yoke so as to generate an offsetting magnetic force. This structure reduces a load on a supporting mechanism of the mover.

However, in the conventional linear motor mentioned above, a magnetic attracting force unidirectionally acts between the armature unit and the mover. Therefore, there is a conventional problem in the fact that a great load is applied on the supporting mechanism of the mover, and hence a distortion occurs in the linear motor, so that the operational accuracy decreases. Additionally, a plurality of windings are wound around the single stator unit, and different windings are wound around the stator magnetic poles adjacent thereto. Therefore, there is another conventional problem in that the structure of the entire linear motor becomes complicated. Additionally, to keep the air-gap constant against a great magnetic attracting force acting between the stator and the mover, accuracy in assembling elements that have undergone precision machining should be increased, and there is a need to increase the number of places to be fastened with, for example, bolts. Therefore, there is still another conventional problem in that the number of process steps for assembly increases.

Additionally, in the linear motor mentioned above (see paragraph [0006] and FIG. 1 to FIG. 4 of JP 10-174418 A), since a magnetic attracting force acting between the stator and the mover is cancelled out to decrease a load on the supporting mechanism of the mover, a magnetic attracting force in a traveling direction in which the linear motor is driven is also reduced. Therefore, there is still another conventional problem in the fact that the efficiency of the linear motor is lowered. Additionally, a plurality of armature windings are wound around the single stator unit. Therefore, there is still another problem in the fact that the structure becomes complex. Additionally, since in this linear motor, armature windings with different magnetic polarity are wound around the adjacent stator magnetic poles, the space occupied by each stator and the magnetic pitch are widened. Therefore, there is still another problem in that the volumetric efficiency is lowered, and hence it is difficult to downsize the linear motor.

### SUMMARY OF THE INVENTION

One aspect of the present invention is to provide a linear motor that has a simple structure and that is capable of being easily assembled with high accuracy, and to provide a driving stage and an XY driving stage both of which have high reliability using this linear motor.

Another aspect of the present invention is to provide a linear motor that includes a primary-side member in which a plurality of magnets are disposed in a traveling direction and a secondary-side member in which armature units and spacers are disposed in the direction of movement and in which the primary-side member and the secondary-side member move relative to each other. The secondary-side member includes an exterior member having a first protrudent-hollow part of one of a dovetail tenon or a dovetail groove and a second protrudent-hollow part of the other of the dovetail groove and the dovetail tenon that is shaped to be fitted to the first protrudent-hollow part. The second protrudent-hollow part and the first protrudent-hollow part are fitted together, and the armature units and the spacers are united together and held by the exterior member. The first protrudent-hollow part may be formed on the spacer or the armature unit that is a component of the secondary-side member.

### BRIEF DESCRIPTION OF THE DRAWINGS

The objects and features of the present invention will easily become apparent from the following detailed description with reference to the attached drawings.

FIG. 1 is an exploded perspective view of the assembly of a linear motor according to a first embodiment of the present invention.

FIG. 2 is a view showing an assembly process of the linear motor assembled based on the exploded perspective view of the assembly of FIG. 1.

FIG. 3 is a perspective view of the linear motor assembled under the process shown in FIG. 2.

FIG. 4 is a perspective view showing a dovetail joint of a dovetail tenon and a dovetail groove to be fitted to each other in the linear motor according to the first embodiment of the present invention.

FIG. 5 is a sectional view of a primary-side member and a secondary-side member of the linear motor according to the first embodiment of the present invention.

FIG. 6A is a sectional view of the primary-side member and the secondary-side member of a linear motor according to a second embodiment of the present invention, and FIG. 6B is a perspective view of the secondary-side member shown in FIG. 6A.

FIG. 7A is a perspective view showing the structure of the linear motor according to the second embodiment of the present invention, and FIG. 7B is a perspective view showing an example in which permanent magnets are used as the primary-side member shown in FIG. 7A.

FIG. 8 is an exploded perspective view of the assembly of a linear motor according to a third embodiment of the present invention.

FIG. 9 is a view showing an assembly process of the linear motor assembled based on the exploded perspective view of the assembly of FIG. 8.

FIG. 10 is a perspective view of the linear motor assembled under the assembly process of FIG. 9.

FIG. 11 is an exploded perspective view of the assembly of a linear motor according to a fourth embodiment of the present invention.

FIG. 12A is a sectional view illustrating a positioning main part of an upper-surface member and spacers in FIG. 11, and shows the not-yet assembled state of the linear motor, whereas FIG. 12B shows the assembled state of the linear motor.

FIG. 13 is an exploded perspective view of a modification of the assembly showing a modification of the linear motor according to the fourth embodiment of the present invention.

FIG. 14 is a perspective view of an XY driving stage to which the linear motor is coupled in a fifth embodiment of the present invention.

FIG. 15 is an exploded perspective view of the assembly of fitting parts of the Y-axis member and the X-axis member in FIG. 14.

FIG. 16 is an exploded perspective view of the assembly of a linear motor according to a sixth embodiment of the present invention.

FIG. 17 is an exploded perspective view of the assembly of a linear motor of a comparative example.

### DETAILED DESCRIPTION OF THE INVENTION

Next, embodiments of the present invention will be described in detail with reference to the accompanying drawings. In these embodiments, the same or substantially the same elements are disganted with the same or substantially the same references, and a repeated description of the same component is omitted.

### First Embodiment

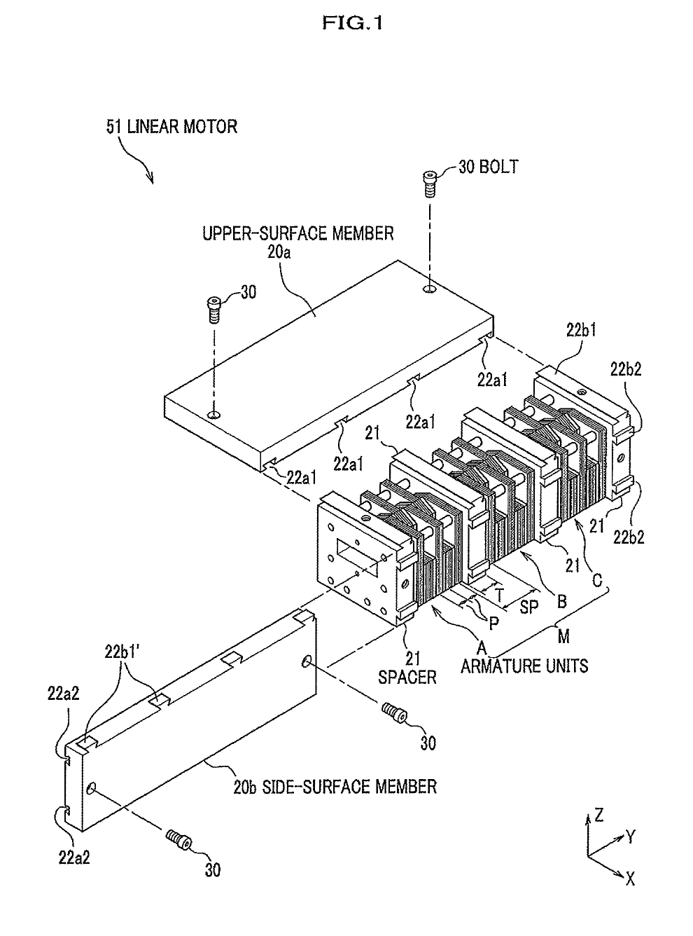

FIG. 1 is an exploded perspective view of the assembly of a linear motor 51 according to a first embodiment of the present invention.

As shown in FIG. 1, spacers 21 are disposed along a traveling direction (i.e., Y direction) between an armature unit A, an armature unit B, and an armature unit C, respectively. The side surfaces of each spacer 21 are provided with protrudent parts (dovetail tenons) 22b1 and 22b2 (first protrudent-hollow parts), respectively. The armature units A, B, C and the spacers 21 are combined together by an upper-surface member (exterior member) 20a, which has hollow parts (dovetail grooves) 22a1 (second protrudent-hollow parts) to be fitted to the dovetail tenons 22b1, respectively, and which slides in the X direction, and a side-surface member (exterior member) 20b, which has hollow parts (dovetail grooves) 22a2 (second protrudent-hollow parts) to be fitted to the dovetail tenons 22b2, respectively, and which slides in the Y direction. The side-surface member 20b additionally has protrudent parts (dovetail tenons) 22b1′ (third protrudent-hollow parts), so that each dovetail tenon 22b1′ is fitted to each dovetail groove 22a1 of the upper-surface member 20a.

The dovetail groove 22a1 is shaped in a gap like such a wedge that the gap gradually expands in the width toward its innermost part from its attachment face to be attached to the spacer 21 (in the Z direction) when seen from the X direction of FIG. 1. Likewise, each of the other dovetail grooves, such as the dovetail grooves 22a2, is shaped like a wedge in such a way as to gradually expand the width of its gap toward its innermost part from its attachment face to be attached to the other member.

Each of the dovetail tenons 22b1 and 22b1′ is shaped like a wedge in such a way as to gradually expand its width in a direction protruding from the attachment face to be attached to each of the side-surface member 20b and the upper-surface member 20a when seen from the X direction of FIG. 1. Likewise, each of the other dovetail tenons, such as the dovetail tenons 22b2, is shaped like a wedge in such a way as to gradually expand its width in a direction protruding from the attachment face to be attached to the other member (toward its forward end).

In other words, each hollow part, such as the dovetail groove 22a1, serves as a “dovetail groove,” whereas each protrudent part, such as the dovetail tenon 22b1, serves as a “dovetail tenon.” Therefore, each dovetail groove and each dovetail tenon to be fitted together have a dovetail groove-tenon relationship.

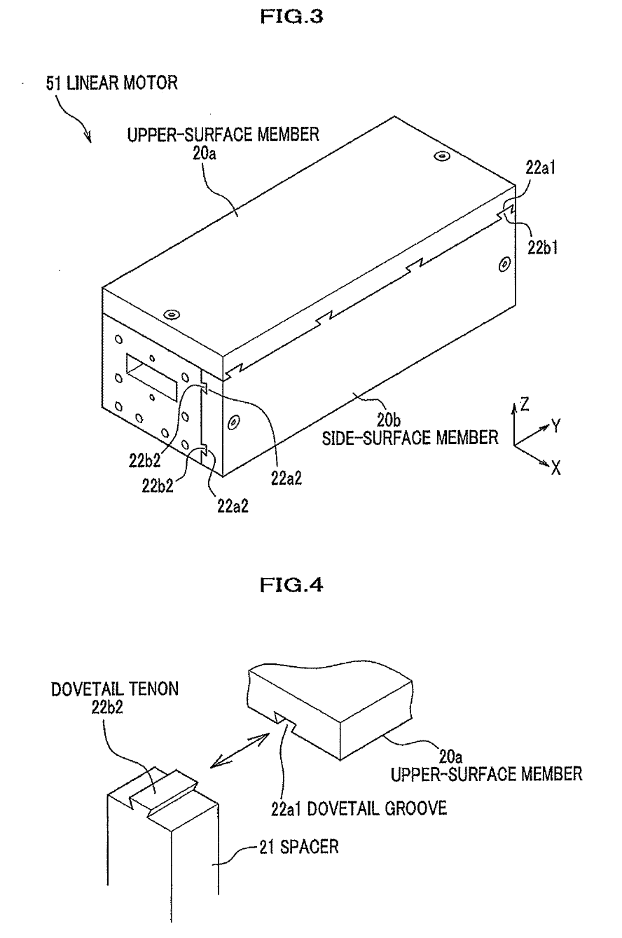

With this shape, the dovetail tenon 22b1 is fitted into the dovetail groove 22a1 when the upper-surface member 20a, the armature units A, B, C, and the spacers 21 are assembled together while being slid in the X direction. At this time, the dovetail groove 22a1 becomes narrower toward the base of the dovetail tenon 22b1 (i.e., becomes wider toward the innermost part), whereas the dovetail tenon 22b1 becomes narrower toward the opening of the dovetail groove 22a1 (i.e., toward the side opposite to the innermost part) (see FIG. 3). Therefore, the dovetail tenon 22b1 and the dovetail groove 22a1 are not easily disengaged from each other, and highly accurate assembly can be achieved.

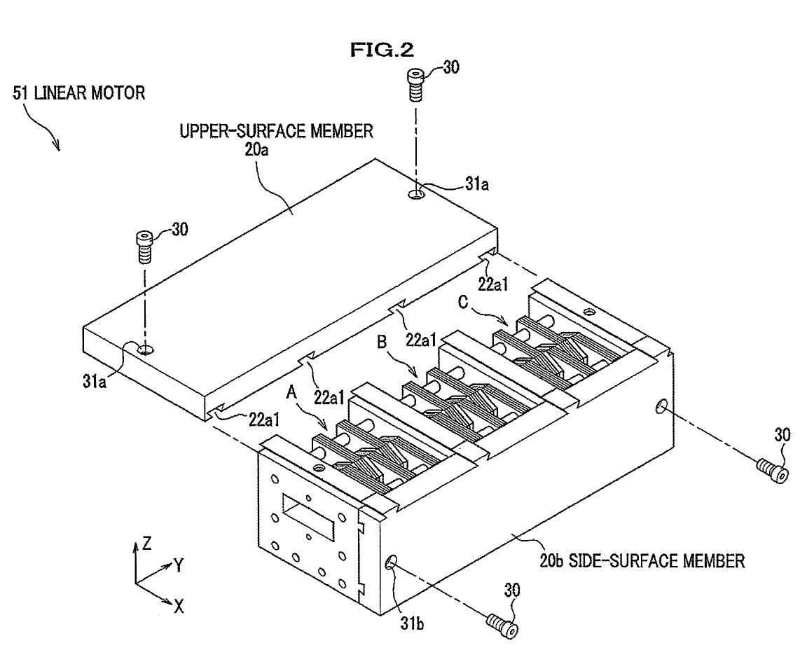

FIG. 2 is a view showing an assembly process of the linear motor 51 assembled based on the exploded perspective view of the assembly shown in FIG. 1.

As shown in FIG. 2, the side-surface member 20b is assembled with the spacers 21 by fitting the dovetail grooves 22a2 of the side-surface member 20b in the side surface so as to be interlocked with the dovetail tenons 22b2 of the spacer 21 disposed between the armature units A, B, and C. Bolts (tightening means) 30 are inserted into through holes 31b of the side-surface member 20b, and are tightened to the spacer 21. Likewise, in this process, the upper-surface member 20a is assembled with the spacers 21 by fitting the dovetail groove 22a1 of the upper-surface member 20a into the dovetail tenon 22b1 of the spacer 21 disposed between the armature units A, B, and C and to be interlocked with the dovetail tenon 22b1′ of the side-surface member 20b. The bolts 30 are inserted into through holes 31a of the upper-surface member 20a, and are tightened to the spacer 21.

FIG. 3 is a perspective view of the linear motor 51 assembled under the process shown in FIG. 2.

FIG. 3 shows a state in which the dovetail tenon 22b1 of the spacer 21 and the dovetail groove 22a1 of the upper-surface member 20a are interlocked with each other and a state in which the dovetail tenon 22b2 of the spacer 21 and the dovetail groove 22a2 of the side-surface member 20b are interlocked with each other. In other words, in the linear motor 51 shown in FIG. 3, two members are assembled, i.e. the upper-surface member 20a extending in the Y direction with the dovetail groove 22a2 to be fitted to the dovetail tenon 22b2 of the spacer 21, and the side-surface member 20b extending in the Y direction with the dovetail groove 22a2 to be fitted to the dovetail tenon 22b2 of the spacer 21. FIG. 3 shows a status where two members are assembled in a dovetail joint at the protrudent-hollow parts, and the two members are fastened to the spacers 21 by use of the bolts 30, respectively. To fasten the members 20a, 20b and the spacers 21 together, pins, rivets, an adhesive, etc., may be used instead of the bolt 30, or soldering or welding may be performed, or these may be used in combination with each other.

Additionally, a dovetail tenon (first protrudent-hollow part, not shown) may be formed on each of the armature units A, B, and C, and a dovetail groove to be fitted to the dovetail tenon (second protrudent-hollow part, not shown) may be formed in the upper-surface member 20a and the side-surface member 20b, and these protrudent-hollow parts may be combined with the dovetail tenons 22b2 of the spacers 21 and be fastened with, for example, bolts 30. Further, the assembling is performed with female screws cut with a tap or with boring pin holes or the like bored so that locking bolts 30 or the like can also be used for the armature units A, B, and C. Further, the side-surface member 20b extending in the Y direction and the upper-surface member 20a extending in the X direction may be formed into a single L-shaped member 20c shaped like the capital letter L (see FIG. 16, described later), and may be combined with the spacers 21.

Herein, the term “secondary-side member” denotes a member including the armature units A, B, C and the spacers 21, and the “exterior member” is the upper-surface member 20a, or the side-surface member 20b, or the L-shaped member 20c (described later) obtained by integrally forming the upper-surface member 20a and the side-surface member 20b. Additionally, the “first protrudent-hollow part” is a hollow part (dovetail groove) or a protrudent part (dovetail tenon) formed on the secondary-side member including the armature units A, B, C and the spacers 21. On the other hand, the “second protrudent-hollow part” is a protrudent part (dovetail tenon) or a hollow part (dovetail groove) formed on the exterior member, such as the upper-surface member 20a or the side-surface member 20b.

Therefore, in the linear motor 51 according to the first embodiment, the first protrudent-hollow part is provided on the secondary-side member including the armature units A, B, C and the spacers 21, and the second protrudent-hollow part to be fitted to the first protrudent-hollow part is provided on the exterior member such as the upper-surface member 20a or the side-surface member 20b. In the thus formed structure, the second protrudent-hollow part formed on the exterior member is fitted to the first protrudent-hollow part formed on the armature units A, B, C and the spacers 21, and, as a result, the armature units A, B, C and the spacers 21 are formed integrally with each other.

FIG. 4 is a perspective view showing a combination of a dovetail tenon and a dovetail groove to be fitted to each other in the linear motor 51 according to the first embodiment of the present invention.

As shown in FIG. 4, the spacer 21 is provided with the dovetail tenon 22b1 formed in a flared shape, whereas the upper-surface member 20a is provided with the dovetail groove 22a1 formed in a convergent shape. The dovetail tenon 22b1 and the dovetail groove 22a1 are interlocked with each other in a dovetail joint by relatively sliding the spacer 21 and the upper-surface member 20a. The spacer 21 may be provided with hollow parts (dovetail grooves), and the upper-surface member 20a may be provided with protruding parts (dovetail tenons). The dovetail groove 22a2 of the side-surface member 20b and the dovetail tenon 22b2 of the spacer 21 are interlocked with each other in a wedge shape in the same way although these are not shown in FIG. 4. That is, each dovetail tenon and each dovetail groove are formed to be fitted together in the dovetail joint.

Here, a description will be given of an interval pitch of the magnetic pole teeth of the adjoining armature units and the thickness of the spacer 21 shown in FIG. 1 and FIG. 2. The interval pitch SP of the magnetic pole teeth of the adjoining armature units is expressed by Equation (1) mentioned below where P is the pole pitch of the armature units A, B, and C, k (k=1, 2, . . . ) is a positive integer that can be freely chosen within the range in which the adjoining armature units can be disposed, and M (M=2, 3, 4, . . . ) is the number of phases of the linear motor when the plurality of armature units A, B, and C are arranged in series:

SP=(k•P+P/M) (1)

The thickness T of the spacer 21 interposed between the magnetic pole teeth of the adjoining armature units is determined to satisfy Equation (1), and is inserted between the adjoining armature units.

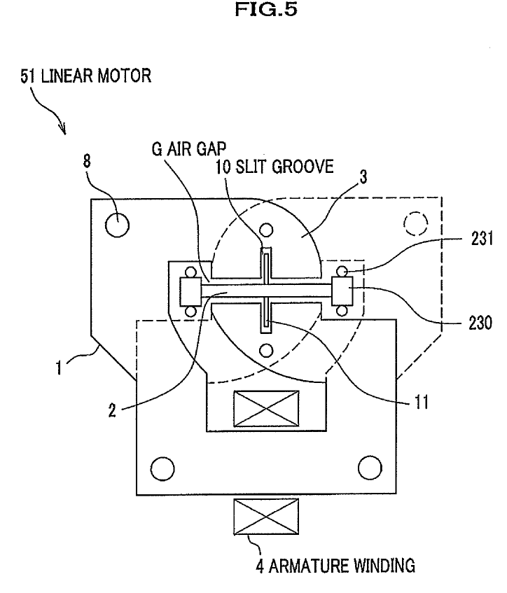

FIG. 5 is a sectional view of a primary-side member and the secondary-side member of the linear motor 51 according to the first embodiment of the present invention.

As shown in FIG. 5, the linear motor 51 is structured so that an armature unit 16 having an armature winding 4 on a ring-shaped core (core) 1 and a primary-side member 2 having a plurality of magnets can move relative to each other. The armature units 16 correspond to the armature units A, B, and C shown by FIG. 1. Therefore, the part shown by the broken line of FIG. 5 is a part of the armature units A, B, and C disposed to face the back side of the armature unit 16 shown by the solid line as shown in the armature units A, B, and C of FIG. 1.

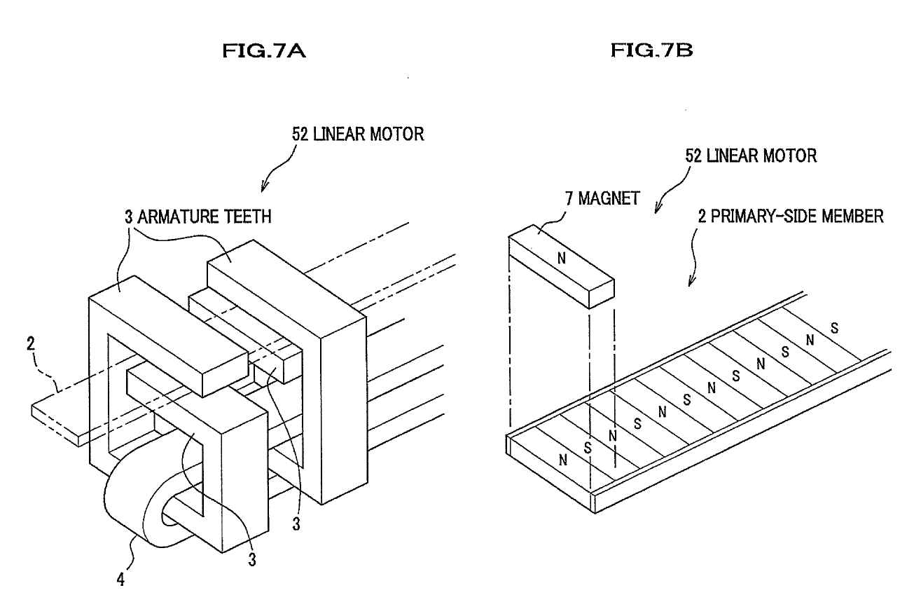

Although permanent magnets are used as the magnets 7 (described later) that form the primary-side member 2 (FIG. 7B) in this embodiment, electromagnets may be used as the magnets 7, or a combination of electromagnets and permanent magnets may be used as the magnets 7. The armature unit 16 of the linear motor 51 has a magnetic circuit including a ring-shaped core 1, a set of armature teeth 3, and an armature winding 4. In a part of the ring-shaped core 1, a slit groove 10 is disposed in the armature teeth 3 facing both sides of the front and back surfaces of the permanent magnet (not shown) of the primary-side member 2 with an air gap G therebetween, thus forming a closed magnetic circuit. A protrudent member 11 movable along the slit groove 10 of the armature teeth 3 is attached to the surface of the magnet 7 of the primary-side member 2.

Further, in a part of the ring-shaped core 1, the armature teeth 3 are disposed so as to face both the front and back surfaces of the permanent magnet of the primary-side member 2 with an air-gap G therebetween, and a guide rail 230 is provided along the longitudinal direction of the permanent magnet of the primary-side member 2 (i.e., along a direction from the reverse side to the obverse side of the drawing sheet). A supporting mechanism 231 is disposed on the side of the ring-shaped core so as to match to the guide rail 230. A through hole 8 through which a bolt (not shown) is passed is formed at each of the four corners of the ring-shaped core 1, so that a plurality of ring-shaped cores 1 can be assembled in parallel.

Although the supporting mechanism 231 is disposed on both sides of the primary-side member 2, the shape of the supporting mechanism 231 and the guide rail (not shown) of the mover may be combined together in a common body. Additionally, a noncontact supporting method by, for example, an air static pressure bearing or a hydrostatic pressure bearing or a supporting method by, for example, plane sliding or a linear guide rail may be employed as the supporting method of the supporting mechanism 231.

In FIG. 5, the armature units 16 (i.e., the armature units A, B, and C of FIG. 1) and the spacers 21(see FIG. 1 and FIG. 2), which are arranged in the traveling direction from the obverse side to the reverse side of the drawing sheet of paper (or from the reverse side to the obverse side thereof), are fastened together by inserting a bolt (not shown) through the through holes 8. In this process, deformation, such as a twist, will easily occur in the armature unit 16 if those are fastened with bolts low in hardness or rigidity. Therefore, bolts having sufficient hardness and rigidity are used.

### Second Embodiment

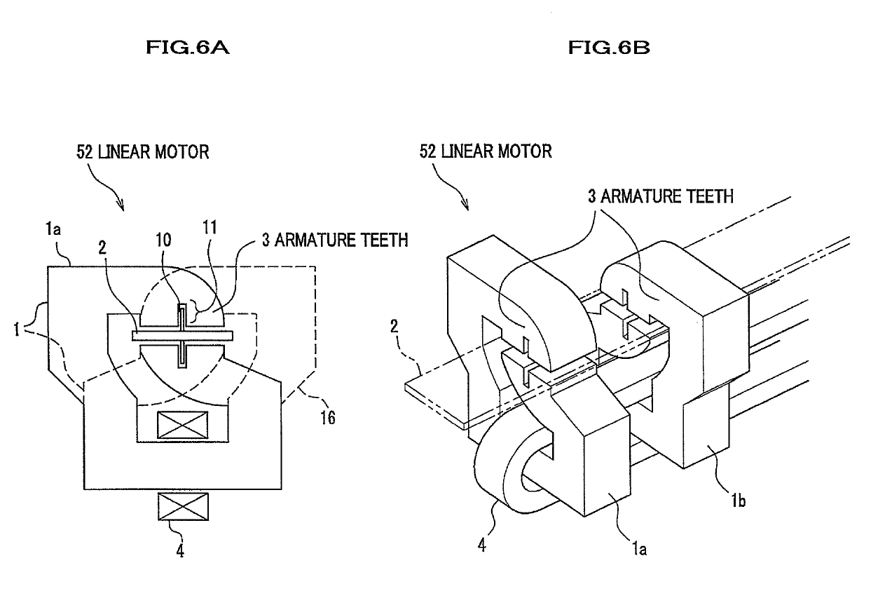

FIG. 6A is a sectional view of the primary-side member and the secondary-side member of a linear motor 52 according to a second embodiment of the present invention, and FIG. 6B is a perspective view of the secondary-side member shown in FIG. 6A.

In detail, FIG. 6A shows a structure in which the through hole 8, the guide rail 230, etc., have been omitted in the linear motor 51 shown in FIG. 5, and FIG. 6B shows a structure in which the armature winding 4 is wound around a front ring-shaped core 1a and a rear ring-shaped core 1b in common. As shown in FIG. 6B, in each set of armature units, the front ring-shaped core 1a and the rear ring-shaped core 1b are disposed to face each other so that the direction of the armature teeth 3 of the front ring-shaped core 1a and the direction of the armature teeth 3 of the rear ring-shaped core 1b alternate with each other, and the armature winding 4 is wound around the front ring-shaped core 1a and the rear ring-shaped core 1b in common.

FIG. 7A is a perspective view showing the structure of the linear motor 52 according to the second embodiment of the present invention, and FIG. 7B is a perspective view showing an example in which permanent magnets are used as the primary-side member 2 shown in FIG. 7A.

In detail, the primary-side member 2 shown in FIG. 7A is a mover, and magnets 7 are disposed in order of N pole, S pole, N pole, and S pole in the direction of movement as shown in FIG. 7B. With this structure, the linear motor 52 performs stepping driving rectilinearly with N-S pitch intervals while allowing the armature teeth 3 to face each magnetic pole of the permanent magnets of the primary-side member 2.

### Third Embodiment

In FIGS. 1 to 3 mentioned above, the spacers 21 are provided with the protrudent parts (dovetail tenons) 22b1 and 22b2, and the upper-surface member 20a and the side-surface member 20b are provided with the hollow parts (dovetail grooves) 22a1 and 22a2, and the assembly is provided by two-plate combining process of combining the upper-surface member 20a and the side-surface member 20b in the X and Y directions. However, in a third embodiment, an example will be described in which the assembly of two-plate combining process in the X and Z directions using the upper-surface member 20a and a side-surface member 20b′ is performed.

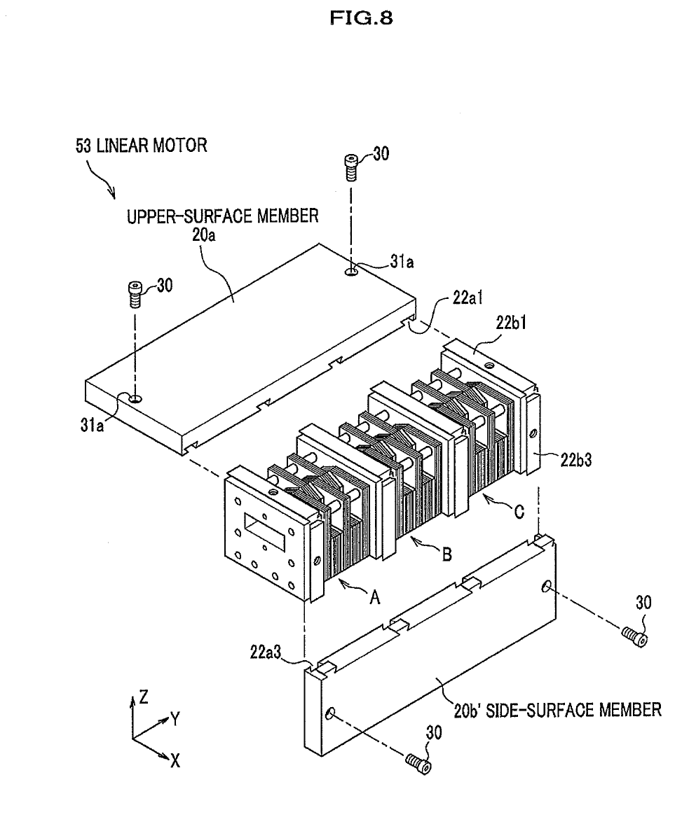

FIG. 8 is an exploded perspective view of the assembly of a linear motor 53 according to a third embodiment of the present invention.

In detail, FIG. 8 is an exploded view showing an example in which the armature units A, B, C and the spacers 21 are assembled together by two-plate combining process of combining the upper-surface member 20a and the side-surface member 20b′ in the X and Z directions. As shown in FIG. 8, the spacers 21 are disposed in the traveling direction between the armature unit A, the armature unit B, and the armature unit C, respectively. Protrudent parts (dovetail tenons 22b1 and 22b3) are attached to the side surfaces of each spacer 21, respectively. The armature units A, B, C and the spacers 21 are integrally combined together by the upper-surface member 20a, which has the hollow parts (dovetail groove) 22a1 to be fitted to the dovetail tenon 22b1 and which slides in the X direction, and by the side-surface member 20b′, which has hollow parts (dovetail grooves) 22a3 to be fitted to a dovetail tenon 22b3 and which slides in the Z direction.

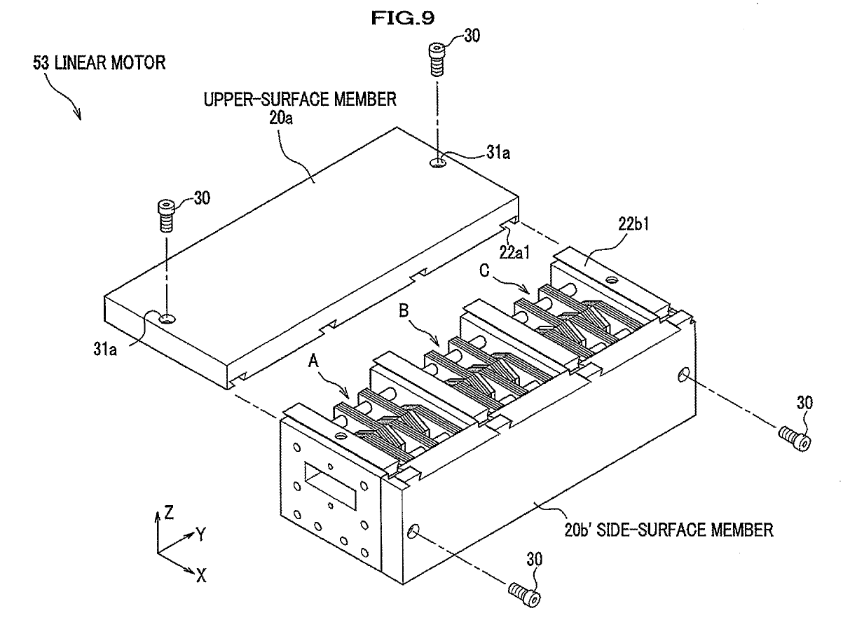

FIG. 9 is a view showing an assembly process of the linear motor 53 assembled based on the exploded perspective view of the assembly of FIG. 8.

In detail, FIG. 9 shows a state in which the side-surface member 20b′ having the dovetail grooves 22a3 to be fitted to the dovetail tenon 22b3 of the spacer 21 has been combined in the up-down direction (i.e., Z direction), and shows a process in which, after having combined the side-surface member 20b′, the upper-surface member 20a having the dovetail grooves 22a1 to be fitted to the dovetail tenons 22b1 of the spacer 21 is combined in the plane direction (i.e., X direction).

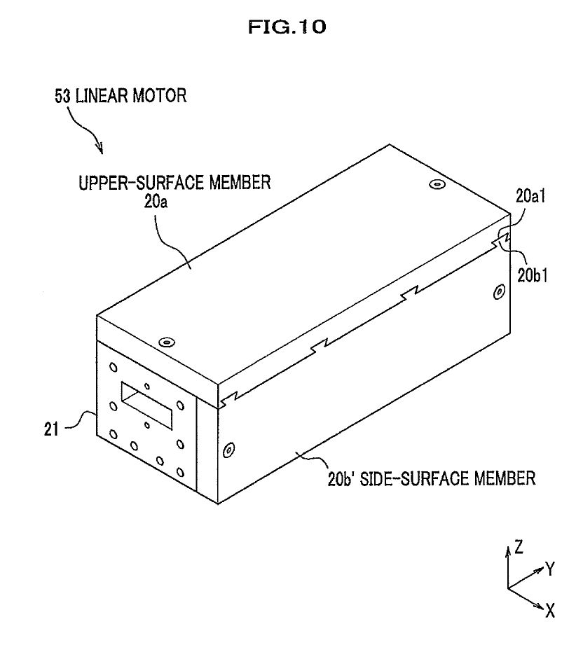

FIG. 10 is a perspective view of the linear motor 53 assembled under the assembly process of FIG. 9.

In detail, FIG. 10 shows a state in which the side-surface member 20b′ is slid in the Z direction so that corresponding protrudent parts and hollow parts are fitted together in a dovetail joint, thereafter the upper-surface member 20a is slid in the X direction so that corresponding protrudent parts and hollow parts are fitted together in a dovetail joint, thereafter the side-surface member 20b′ and the upper-surface member 20a are combined together by two-surface wedge processing, and required portions are firmly fastened with bolts 30.

### Fourth Embodiment

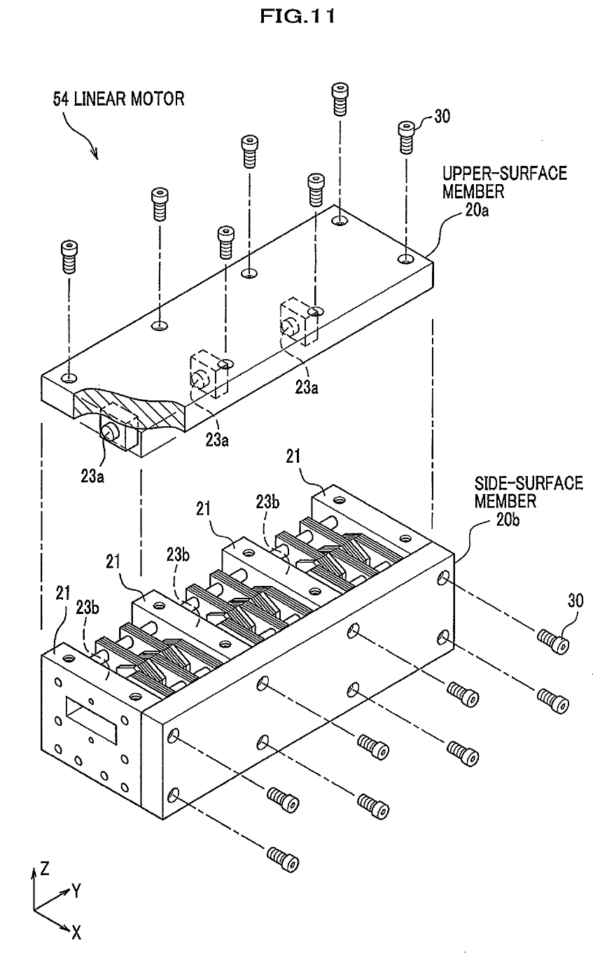

FIG. 11 is an exploded perspective view of the assembly of a linear motor according to a fourth embodiment of the present invention.

In detail, if the armature units A, B, C and the spacers 21 have positioning hollow (bored) parts (positioning holes) 23b, and if the upper-surface member 20a has positioning protrudent parts (positioning boss) 23a to be fitted to the positioning dovetail grooves 23b, respectively, as shown in FIG. 11, the upper-surface member 20a can be easily positioned and attached to the armature units A, B, C and the spacers 21.

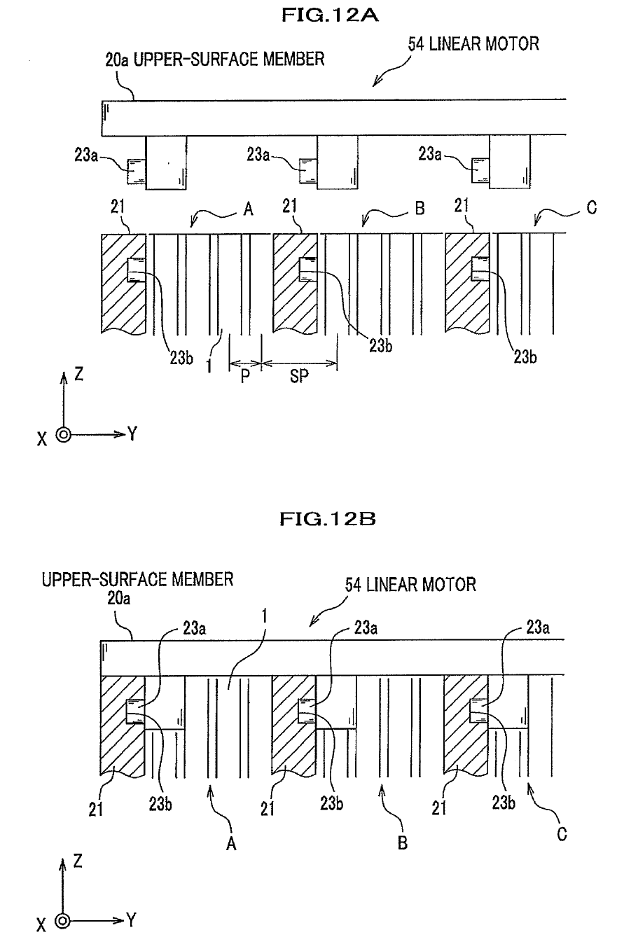

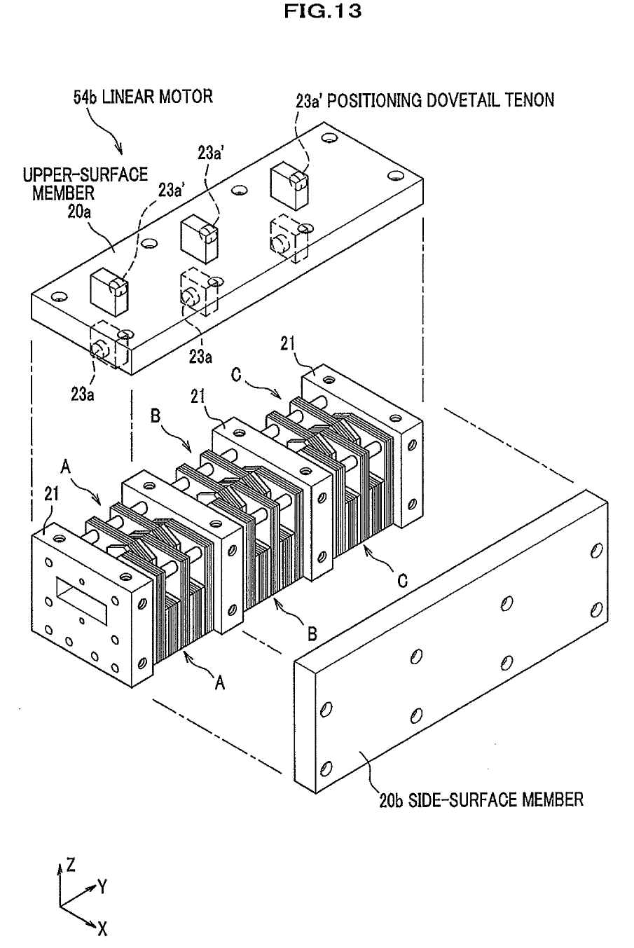

FIG. 12A is a sectional view illustrating a positioning main part of the upper-surface member 20a and the spacers 21 in FIG. 11, and shows the not-yet assembled state of the linear motor, and FIG. 12B shows the assembled state of the linear motor.

In detail, as shown in FIG. 12A, the upper-surface member 20a has the positioning bosses 23a, and each spacer 21 has the positioning hole 23b at a place where the positioning boss 23a are fitted to the positioning hole 23b. With this structure, the upper-surface member 20a and the spacers 21 can be accurately positioned and assembled together as shown in FIG. 12B.

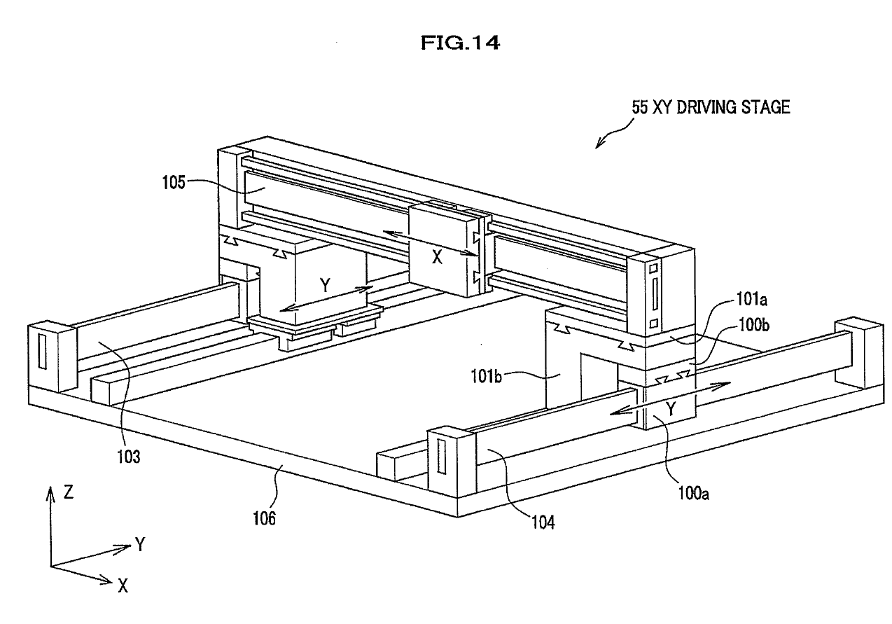

FIG. 13 is an exploded perspective view of the assembly showing a modification of the linear motor 54 according to the fourth embodiment of the present invention.

In detail, the linear motor 54b of FIG. 13 has positioning protrudent parts (positioning bosses) 23a′ on the front surface of the upper-surface member 20a, in addition to the structure of FIG. 11. In the structure where the positioning bosses 23a and 23a′ are provided on both sides of the front and back surfaces of the upper-surface member 20a in this way, for example, when the liner motor 54b is mounted on a large-sized XY driving stage (not shown), providing positioning hollow parts (positioning holes), which can be fitted into the positioning bosses 23a′, allows the linear motor 54b of this embodiment to be mounted on the XY driving stage by the positioning function provided by the protrudent parts fitting into the hollow parts. Therefore, positioning between the linear motor 54b and the main body of the XY driving stage can be easily performed, and the rigidity of both the linear motor 54b and the main body of the XY driving stage can be increased.

### Fifth Embodiment

FIG. 14 is a perspective view showing the entire structure formed when the linear motor 51 is united with an XY driving stage 55 in a fifth embodiment of the present invention.

In detail, FIG. 14 shows the XY driving stage 55 in which one X shaft 105 is mounted on two Y shafts (Y-axis members) 103 and 104 disposed on both sides. In the Y shaft 104, a linear-motor-side member 100a having dovetail tenons (sixth and seventh protrudent-hollow parts) is fitted to an XY-driving-stage-side member 100b having dovetail grooves (sixth and seventh protrudent-hollow parts) at the protrudent-hollow parts, so that these are assembled in a wedge shape. Additionally, a Y-shaft-side member 101b having dovetail grooves and an X-shaft-side member 101a having dovetail tenons are fitted together at the protrudent-hollow parts, so that these are assembled in a wedge shape. With this structure, the components can be easily combined together and be positioned, and the rigidity of both the linear motor and the main body of the XY driving stage can be heightened.

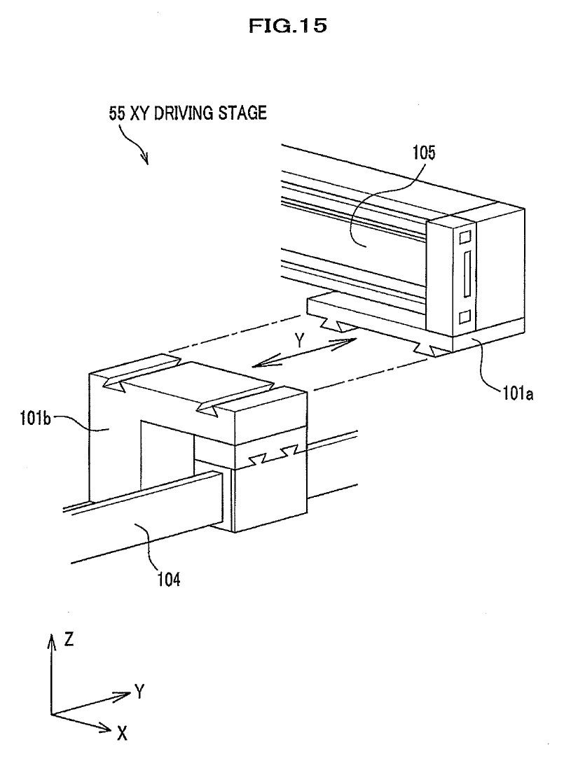

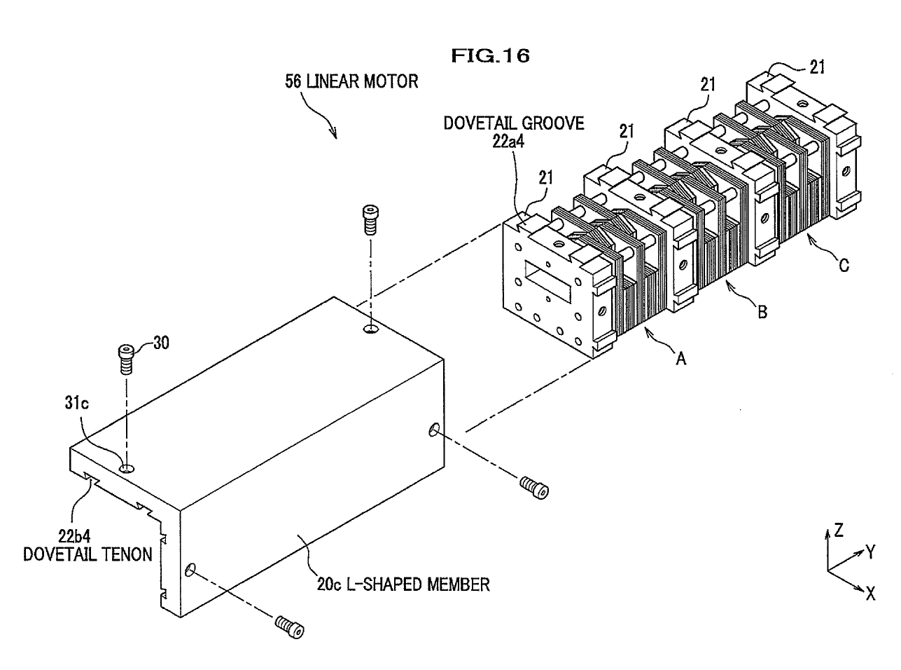

FIG. 15 is an exploded perspective view of the assembly of fitted parts of the Y shaft 104 and the X shaft 105 in FIG. 14.

As shown in FIG. 15, in the XY driving stage 55, when the Y-shaft-side member 101b having the dovetail grooves provided at the Y shaft 104 and the X-shaft-side member 101a having the dovetail tenons provided at the X shaft 105 are slid relative to each other in the Y-axis direction, the side of the Y shaft 104 and the side of the X shaft 105 are assembled in a wedge shape by a function by which the parts are fitted together at the protrudent-hollow parts.

Herein, the linear motor can be applied to a driving stage that moves only in the one-dimensional direction, without being limited to the XY driving stage. In other words, in the XY driving stage 55 of FIG. 15, the X-shaft-side member 101a or the Y-shaft-side member 101b is fixed to a base 106, and the side of the Y shaft 104 is removed, and, as a result, a driving stage is provided.

### Sixth Embodiment

FIG. 16 is an exploded perspective view of the assembly of a linear motor 56 according to a sixth embodiment of the present invention.

In the sixth embodiment, the side-surface member 20b in the Y direction and the upper-surface member 20a in the X direction shown in FIG. 1 are formed into the single L-shaped member 20c shaped like the capital letter L, and the spacers 21 and the armature units A, B, and C are combined together. In detail, as shown in FIG. 16, when the structural components including the L-shaped member (exterior member) 20c, the spacers 21, and the armature units A, B, and C are slid relative to each other, a dovetail groove (second protrudent-hollow part) 22a4 of the L-shaped member 20c and a dovetail tenon (first protrudent-hollow part) 22b4 of the spacer 21 are fitted together, and the structural components including the L-shaped member 20c, the spacers 21, and the armature units A, B, and C can be assembled together in a wedge shape. After being assembled, a bolt 30 is passed through a through hole 31c, and is firmly tightened.

### Comparative Example

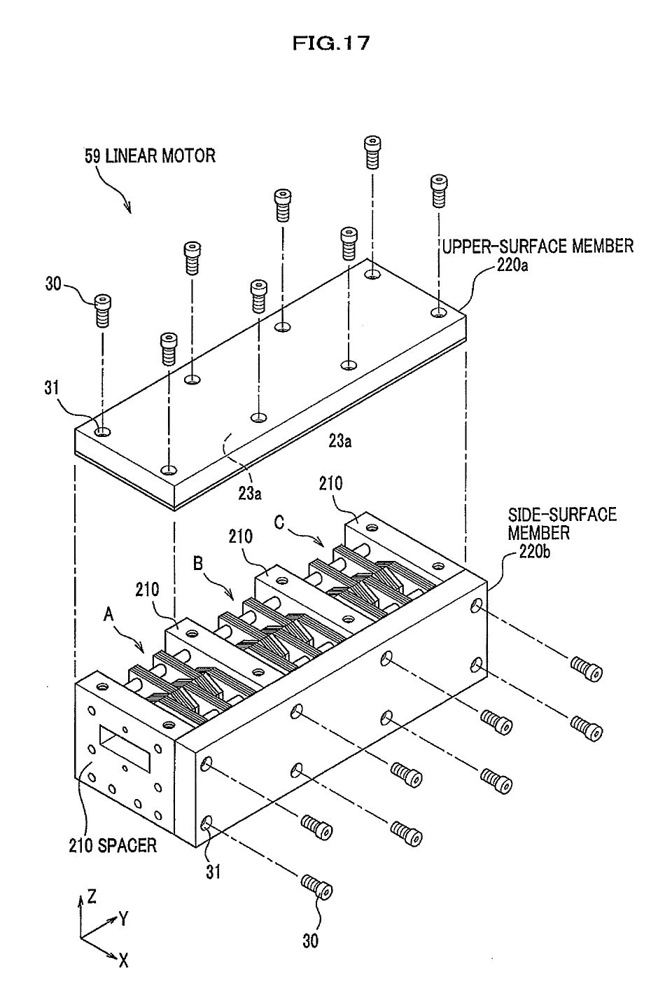

FIG. 17 is an exploded perspective view of the assembly of a linear motor 59 of a comparative example considered by the present inventor for a comparative explanation.

As shown in FIG. 17, many through holes 31 are formed in a side-surface member 220b to be applied to the side surface of the linear motor 59 including the armature units A, B, C and the spacers 210 and in an upper-surface member 220a to be applied to the upper surface thereof, and are fastened to the spacers 210 by many bolts 30. At this time, the force by which each bolt 30 is tightened must be made even, and the armature units A, B, C and the spacers 210 must be integrally combined together with high accuracy while maintaining the vertical and horizontal state of these components. Therefore, it is extremely difficult to perform the assembly of the linear motor 59. Additionally, since the number of components increases, the number of process steps increases, and the failure rate rises.

However, in the linear motors 51, 52, 53, 54, 54b, and 56 (hereinafter, referred to generically as the “linear motor 50”) according to the embodiments of the present invention, both of a combination in which the mover is disposed on the permanent-magnet side whereas the stator is disposed on the armature-winding side and a combination in which the mover is disposed on the armature-winding side whereas the stator is disposed on the permanent-magnet side can be achieved with an extremely small number of components. Therefore, according to this embodiment, a highly accurate linear motor 50 can be assembled through only a few process steps, and the failure rate decreases, and the reliability rises.

Besides the embodiments mentioned above, the linear motor 50 can be assembled by a combination in which only a part of each embodiment is employed. Additionally, the structural components of the linear motor 50 shown in the drawings used in each embodiment may be combined together by straddling the reference numerals designated in the drawings, or these structural components may be integrally combined together by hybridizing or molding a combination of these structural components.

According to each embodiment of the present invention, when the armature units A, B, and C including the core and the armature windings 4 disposed along the direction of movement and the spacers 21 interposed between the armature units A, B, and C are united together by the exterior member (i.e., the upper-surface member 20a, the side-surface members 20b and 20b′, or the L-shaped member 20c), these can be easily united together while maintaining the vertical and horizontal state of the armature units A, B, C and the spacers 21, and the rigidity of the armature units A, B, C and the exterior member can be heightened. In other words, deformation caused by a magnetic attracting force acting between the stator (i.e., the secondary-side member including the armature units A, B, C and the spacers 21) of the linear motor 50 and the mover (i.e., the primary-side member) can be mechanically prevented by fitting the first protrudent-hollow part of the secondary-side member and the second protrudent-hollow part of the exterior member to each other. As a result, the structure of the linear motor 50 becomes less deformable by the magnetic attracting force acting between the stator and the mover. Additionally, the rigidity of both the linear motor 50 and the main body of the XY driving stage is heightened. Therefore, when the linear motor 50 is applied to the XY driving stage 55, positioning for assembly can be easily performed, and the XY driving stage 55 can be structured with high accuracy.

Since the linear motor of the present invention can be assembled with a small number of components and with high accuracy, the linear motor can be effectively used for various precision machine tools or NC machine tools as well as for the XY driving stage.

What is claimed is:

1. A linear motor comprising:
a primary-side member comprising a plurality of magnets disposed in a traveling direction;
a secondary-side member comprising armature units, each including cores and armature windings, and spacers, each being interposed between the armature units disposed in the traveling direction; and
an exterior member;
wherein the primary-side member and the secondary-side member move relative to each other,
the secondary-side member comprises a first protrudent-hollow part including one of a dovetail tenon and a dovetail groove,
the exterior member comprises a second protrudent-hollow part including the other of the dovetail groove and the dovetail tenon shaped to be fitted to the first protrudent-hollow part,
the second protrudent-hollow part and the first protrudent-hollow part are fitted together, and
the exterior member integrally supports the armature units and the spacers.

2. A linear motor comprising:
a primary-side member comprising a plurality of magnets disposed in a traveling direction;
a secondary-side member comprising armature units, each including cores and armature windings, and spacers, each being interposed between the armature units disposed in the traveling direction; and
an exterior member;
wherein the primary-side member and the secondary-side member move relative to each other,
the spacer comprises a first protrudent-hollow part including one of a dovetail tenon and a dovetail groove,
the exterior member comprises a second protrudent-hollow part including the other of the dovetail groove and the dovetail tenon shaped to be fitted to the first protrudent-hollow part,
the second protrudent-hollow part and the first protrudent-hollow part are fitted together, and
the exterior member integrally supports the armature units and the spacers.

3. A linear motor comprising:
a primary-side member comprising a plurality of magnets disposed in a traveling direction;
a secondary-side member comprising armature units, each including cores and armature windings, and spacers, each being interposed between the armature units disposed in the traveling direction; and
an exterior member;
wherein the primary-side member and the secondary-side member move relative to each other,
the armature unit comprises a first protrudent-hollow part including one of a dovetail tenon and a dovetail groove,
the exterior member comprises a second protrudent-hollow part including the other of the dovetail groove and the dovetail tenon shaped to be fitted to the first protrudent-hollow part,
the second protrudent-hollow part and the first protrudent-hollow part are fitted together, and
the exterior member integrally supports the armature units and the spacers.

4. The linear motor according to claim 1, wherein the secondary-side member comprises the first protrudent-hollow part on a plurality of surfaces along the direction of movement,
the exterior member comprises a plurality of members with which at least two of the plurality of surfaces of the secondary-side member are covered,
each of the exterior members comprises a second protrudent-hollow part to be correspondingly fitted to the first protrudent-hollow part and a third protrudent-hollow part by which the exterior members can be fitted together, and
the armature units and the spacers are united together and held by the exterior members.

5. The linear motor according to claim 1, wherein each of the first protrudent-hollow part, the second protrudent-hollow part, and the third protrudent-hollow part is either a dovetail groove in which a cross-section that crosses the direction of movement widens toward an innermost part thereof or a dovetail tenon in which the cross-section that crosses the direction of movement widens toward a forward end thereof.

6. A linear motor comprising:
a primary-side member in which a plurality of magnets are disposed in a traveling direction;
a secondary-side member in which armature units each of which comprises cores and armature windings and spacers each of which is interposed between the armature units are disposed in the traveling direction; and
an exterior member;
wherein the primary-side member and the secondary-side member move relative to each other,
the secondary-side member comprises a first protrudent-hollow part bored or protruding in parallel with a plane along the secondary-side member,
the exterior member comprises an exterior part including a second protrudent-hollow part bored or projected in parallel with the first protrudent-hollow part when the exterior member is attached to the secondary-side member,
the second protrudent-hollow part and the first protrudent-hollow part are fitted together, and
the armature units and the spacers are united together and held by the exterior member.

7. The linear motor according to claim 1, wherein the armature units are arranged in series and a pitch interval SP of magnetic pole teeth of the armature units adjacent to each other is given by SP=(k·P+P/M) where P is a pole pitch of the armature unit, k is an arbitrary, positive integer in a range in which the armature units adjacent to each other can be disposed, and M is a the number of phases of the linear motor.

8. The linear motor according to claim 1, wherein the armature units are arranged in series, and the spacer is interposed between the armature units and comprises such a thickness that the thickness is determined by the pitch interval SP, disposed adjacent to the armature units, which is given by SP=(k•P+P/M) where P is a pole pitch of the armature unit, k is an arbitrary, positive integer in a range in which the armature units adjacent to each other can be disposed, and M is the number of phases of the linear motor.

9. The linear motor according to claim 1, wherein the armature unit comprises a closed magnetic circuit by a structure in which an air-gap is provided so as to face both sides of front and back surfaces of the primary-side member.

10. The linear motor according to claim 1, further comprising a fastening means for firmly fastening the secondary-side member and the exterior member together after the armature units and the spacers have been combined together by the exterior member.

11. A driving stage wherein a primary-side member and a secondary-side member are moved relative to each other by means of the linear motor of claim 1,
the primary-side member comprises a fourth protrudent-hollow part that is a dovetail groove in which a cross-section crossing a direction of movement widens toward an innermost part thereof or a dovetail tenon in which the cross-section crossing the direction of movement widens toward a forward end thereof,
the secondary-side member comprises a fifth protrudent-hollow part that is a dovetail groove that is fitted to the fourth protrudent-hollow part and in which a cross-section crossing a direction of movement widens toward an innermost part thereof or a dovetail tenon that is fitted to the fourth protrudent-hollow part and in which the cross-section crossing the direction of movement widens toward a forward end thereof, and
the fourth protrudent-hollow part and the fifth protrudent-hollow part are fitted together and are slid by the linear motor.

12. An XY driving stage that is moved along an X axis by the first linear motor of claim 1 and that is moved along a Y axis by the second linear motor of claim 1, the XY driving stage comprising:
a fourth protrudent-hollow part that is a dovetail groove that is extended along the X axis and in which a cross-section crossing a direction of movement widens toward an innermost part thereof or a dovetail tenon that is extended along the X axis and in which the cross-section crossing the direction of movement widens toward a forward end thereof;
a fifth protrudent-hollow part that is a dovetail groove that is extended along the X axis, that is fitted to the fourth protrudent-hollow part, and in which a cross-section crossing a direction of movement widens toward an innermost part thereof or a dovetail tenon that is extended along the X axis, that is fitted to the fourth protrudent-hollow part, and in which the cross-section crossing the direction of movement widens toward a forward end thereof;
a sixth protrudent-hollow part that is a dovetail groove that is extended along the Y axis and in which a cross-section crossing a direction of movement widens toward an innermost part thereof or a dovetail tenon that is extended along the Y axis and in which the cross-section crossing the direction of movement widens toward a forward end thereof; and
a seventh protrudent-hollow part that is a dovetail groove that is extended along the Y axis, that is fitted to the sixth protrudent-hollow part, and in which a cross-section crossing a direction of movement widens toward an innermost part thereof or a dovetail tenon that is extended along the Y axis, that is fitted to the sixth protrudent-hollow part, and in which the cross-section crossing the direction of movement widens toward a forward end thereof;
wherein the fourth protrudent-hollow part and the fifth protrudent-hollow part are fitted together, and are slid by the first linear motor, and
the sixth protrudent-hollow part and the seventh protrudent-hollow part are fitted together, and are slid by the second linear motor.
